(19) United States
(12) Patent Application Publication
(10) Pub. No.: US 2006/0038073 A1
(43) Pub. Date: Feb. 23, 2006

(54) Light weight vacuum vessel provides lift for airships

(76) Inventor: John Robert Shearing, Moonachie, NJ (US)

Correspondence Address: John R Shearing, 55 E Joseph St, Moonachie, NJ, 07074, US

(21) Appl. No.: 11/049,576

(22) Filed: Feb. 2, 2005

Related U.S. Application Data
(60) Provisional application No. 60/541,292, filed on Feb. 3, 2004.

(51) Int. Cl. B64B 1/02

(52) U.S. Cl. 244/125

(57) ABSTRACT

A tubular container having a fabric shell formed and supported by suspension cables that are stretched between tower arrays that also serve to enclose the ends of the tube. This structure may be used as a building, a pressure vessel, a vacuum vessel, or as a container. If configured as a vacuum vessel and made with the super strong lightweight materials, then it is possible to create a lighter than air structure that will float in the atmosphere when evacuated of air.

### CROSS-REFERENCE TO RELATED APPLICATIONS

This application claims benefit of priority to provisional patent application of the same title filed on Feb. 03, 2004 and assigned U.S. PTO application No. 60/541,292.

### STATEMENT REGUARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Most everyone involved with airships has wondered if it would be possible to use vacuum bottles instead of helium filled ballonets to provide lift for airships. After all, a vacuum is even lighter than helium. And by using relief valves and vacuum pumps, vertical takeoffs and landings would be possible.

When constructing our vacuum bottles, there is really only one important consideration. The bottles must be lighter than the air they displace. This is what gives the bottles positive buoyancy and allows them to float.

So far, So good . . . except for one thing . . . At sea level, the atmosphere exerts the enormous crushing force of more than 2000 pounds per square foot along the surface of the bottles. So using conventional materials, and conventional construction techniques, there were two possible outcomes for your efforts. Either the bottles were able to stand up to atmospheric pressure; in which case, the bottles were too heavy to float. Or the bottles were light enough to float, but were crushed under the weight of the atmosphere. In either case, your airship never got off the ground.

This document defines materials and methods that will facilitate the production of vacuum bottles that are lighter than the air they displace, while being strong enough to stand up to atmospheric pressure.

### DESCRIPTION OF PRIOR ART

In U.S. Pat. No. (4,113,206), David Wheeler describes a geodesic structure that is lighter than the air it displaces. The intent is to evacuate the air from inside the structure so that the structure will float in the atmosphere. But even with today's super strong and super light composite materials, a working model has never been built.

Known in the prior art are vacuum vessels made either by joining cylindrically contoured sections together, by capping the ends of tubing, by filament winding techniques, and geodesic construction. All of these structures have one thing in common, and that is, the tension and compression members are one and the same. In other words, if a point load is placed on the outside of the vessel, then the outside of the vessel will be in compression while inside will respond with tension. Any structure where one side of a member is in tension while the other side is in compression can be very brittle. An egg is a good example. The construction techniques used in my invention ensure that members are either in tension or compression, but not both. This has three advantages: First, because the tension and compression members are separate and distinct, you can create some distance between them. This gives great toughness and flexibility. A suspension bridge is a good example of this. Toughness and flexibility are very important in rigid airship design because wind shear and impact are very common modes of failure and disaster. Second, you can optimize rather than compromise the members for either tension or compression strength. This results in members of much less weight for the same strength. And third, all of the new super strong, super lightweight, and super expensive materials, exhibit their strength in tension only. So having separate and distinct tension and compression members allows the designer to build the compression members from less expensive materials.

Another problem with the typical vacuum vessel is that, when under uniform load such as by atmospheric pressure, the entire structure is under a compressive load. But as mentioned before, today's super strong materials exhibit their strength in tension not compression. My invention demonstrates a way to place the outside of the vacuum vessel in tension rather than compression. This allows us to take maximum advantage of the strength that today's materials can offer. And this in turn allows us to build a much lighter vacuum vessel for the same displacement. At this point, it is important to note, that as far as I know, and with the exception of my other inventions, (10/342767, 10/383444, and 60/617403), this is the only vacuum vessel ever conceived in which the entire surface of the vessel is in tension rather than compression.

### BRIEF SUMMARY OF THE INVENTION

The purpose of this invention is to provide a new structure (from here on called a suspension enclosure) for use underwater and in the air. When used in the air, the invention is a new type of vacuum container (from here on called a vacustat) that has the properties of being lighter than the air it displaces yet being strong enough to stand up to atmospheric pressure. This vacustat will float when evacuated of air and will find enormous use in the airship industry, which is now dependent on helium filled ballonets to provide lift. When used underwater, the invention provides a lightweight flexible hull that can stand up to enormous pressure. This is accomplished by combining the use of super strong, super light materials such as graphite or Kevlar, which exhibit most of their strength in tension, with a structure that places these materials in tension.

### BRIEF DESCRIPTION OF THE DRAWINGS

FIG. 1 shows the completed vacuum vessel, which will from here on be called a suspension enclosure.

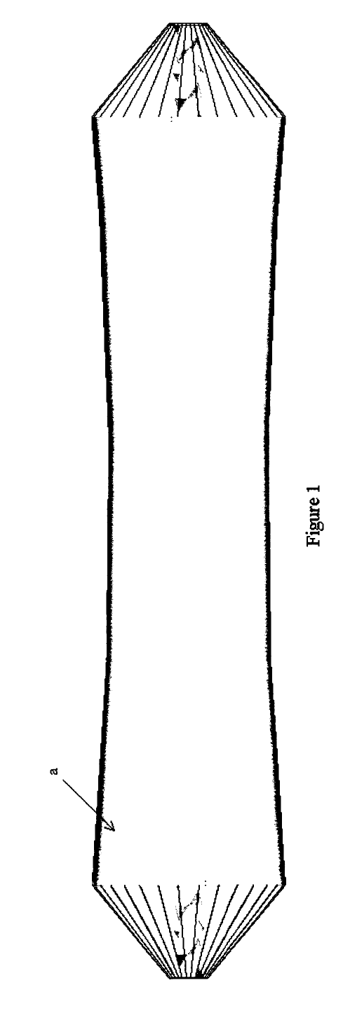

FIG. 2 shows that construction starts with a lightweight column. The one shown here is called IsoTruss. See U.S. Pat. No. 5,921,048 for a full description of this column. Other types of columns can be used.

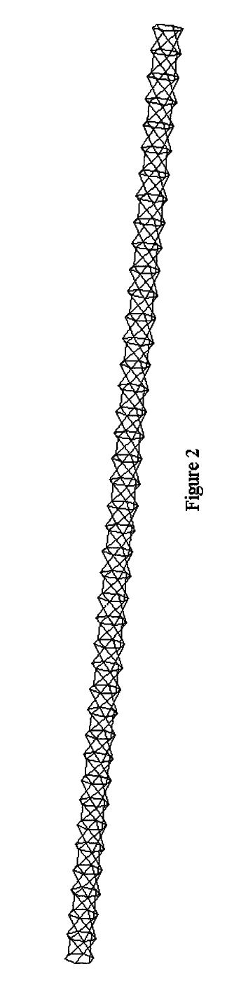

FIG. 3 shows the first step in the construction of a suspension enclosure in this preferred embodiment, which is capping the end of the column. This cap will later serve as an anchor point for suspension cables

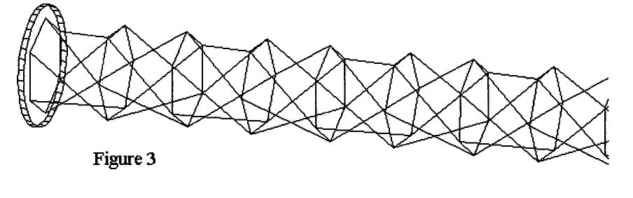

FIG. 4 shows the end cap of the vacuum vessel. This piece will also serve as a tower to support suspension cables and will be referred to as a freestanding balanced suspension tower array. You can think of the freestanding balanced suspension tower array as an array of suspension towers about an axis of revolution.

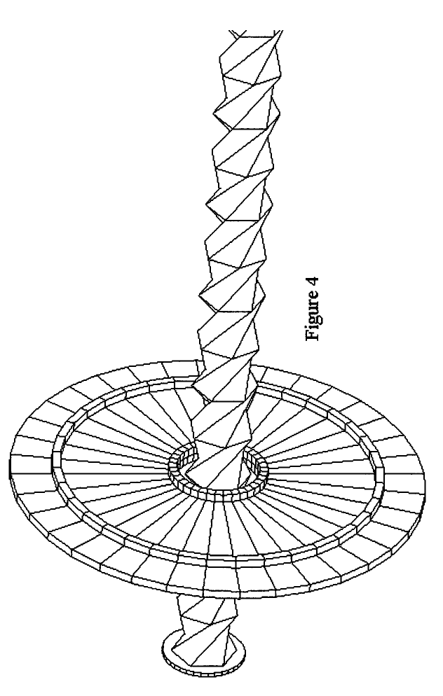

FIG. 5 highlights the ridges (a) and (b) on the end caps in this preferred embodiment, which are used for attaching inner and outer high strength airtight fabric tubes. The area between (a) and (b) will hold a vacuum.

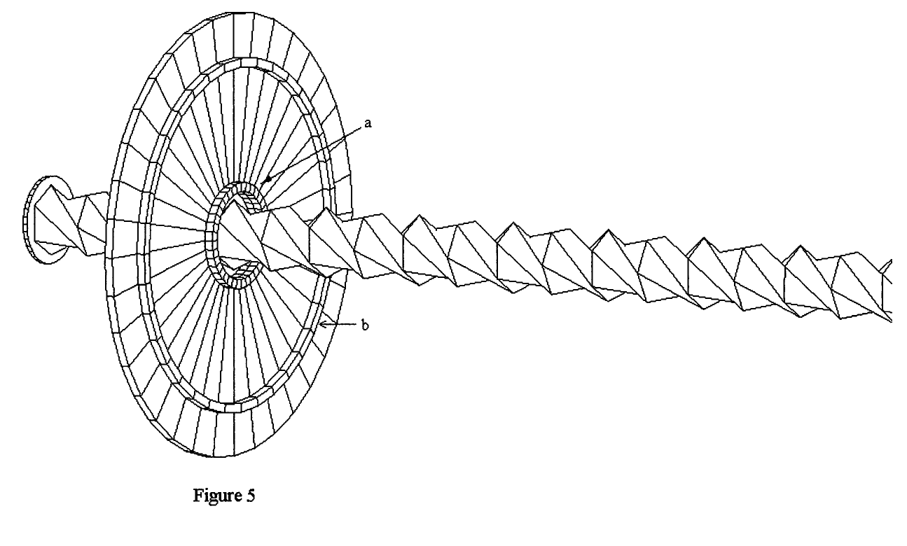

FIG. 6 shows the construction of one preferred embodiment where an inner airtight fabric tube (a) is attached to the inner ridge of the end caps by the use of a rather large hose clamp (b).

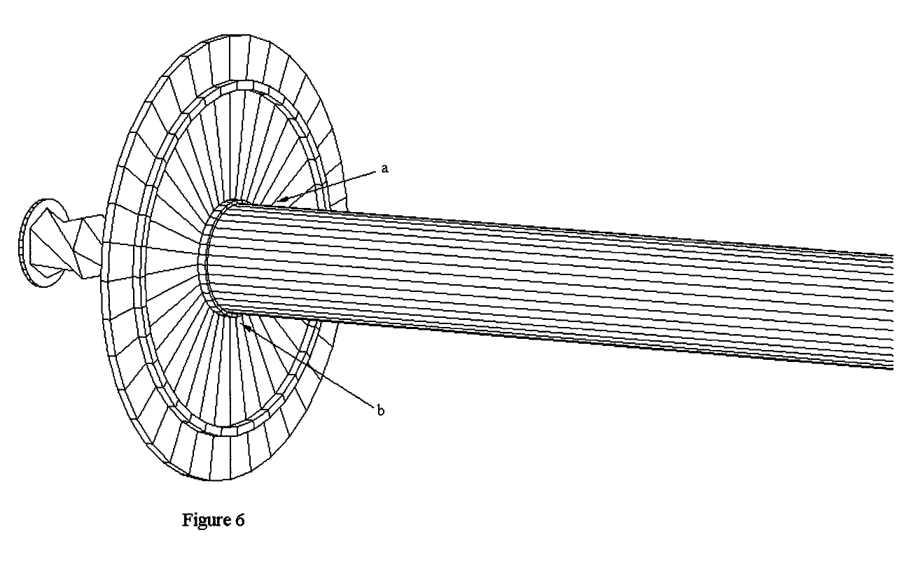

FIG. 7 shows the outer airtight fabric tube of this preferred embodiment being attached to an end cap by the same method shown in FIG. 6.

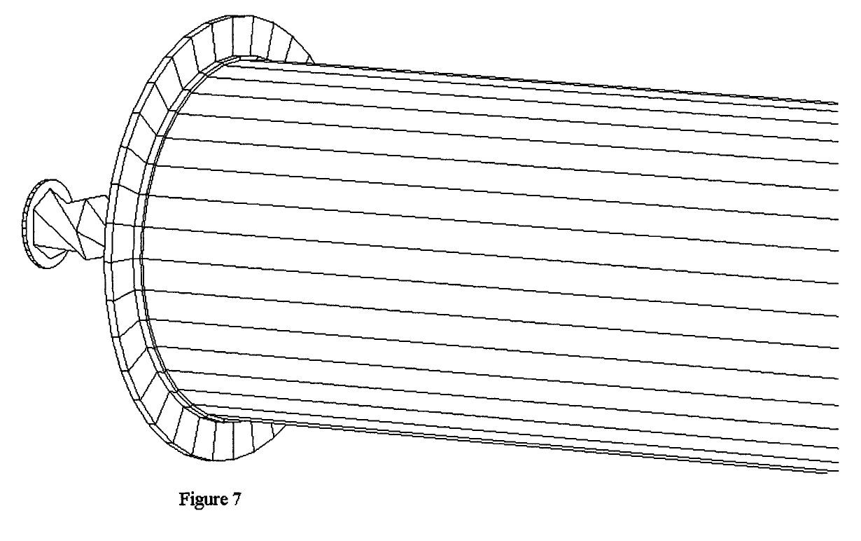

FIG. 8 shows end cables (a) attached and tensioned just enough to pull the structure into shape.

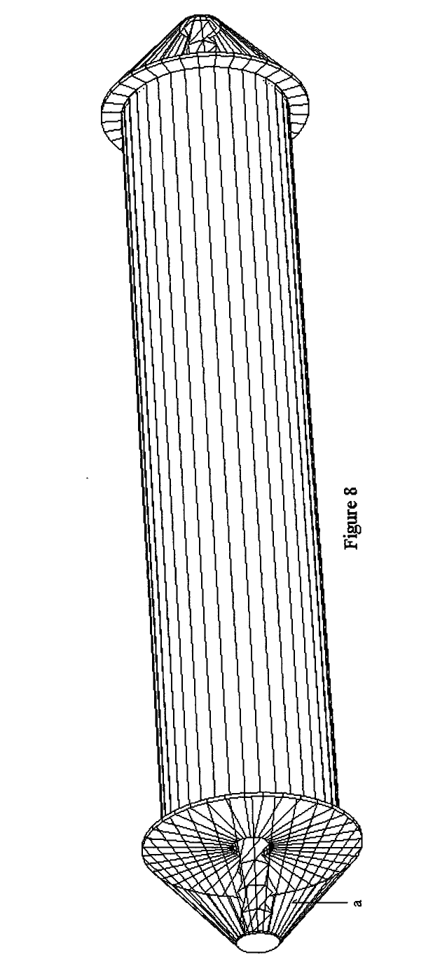

FIG. 9 finishes construction of the invention in one of its preferred embodiments where suspension cables (a) are stretched between the two freestanding balanced suspension tower arrays (b) and fastened in place. Cable stays (c) are attached to the suspension cables (a) and extend radially in towards the center of the structure. In this embodiment, the other ends of the cable stays (c) are attached to the outer airtight fabric tube (d) in order to keep the tube from collapsing when the air inside is evacuated. The advantage of this embodiment is that the outer tube is in the shape of a cylinder, which is an easy shape to fabricate. In fact, the tubing fabric can be pull-truded or woven as a single piece to any desired length. This will greatly reduce the cost of manufacture and assembly when compared to vacuum vessels built from cylindrical sections. Please note that although the end caps (b) also serve as the freestanding balanced suspension tower array (b) in this embodiment, they could just as well be separate items. It is not the purpose of this document to demonstrate a new way to cap the end of a tube, but rather to demonstrate a new way to support a tube against outside pressure.

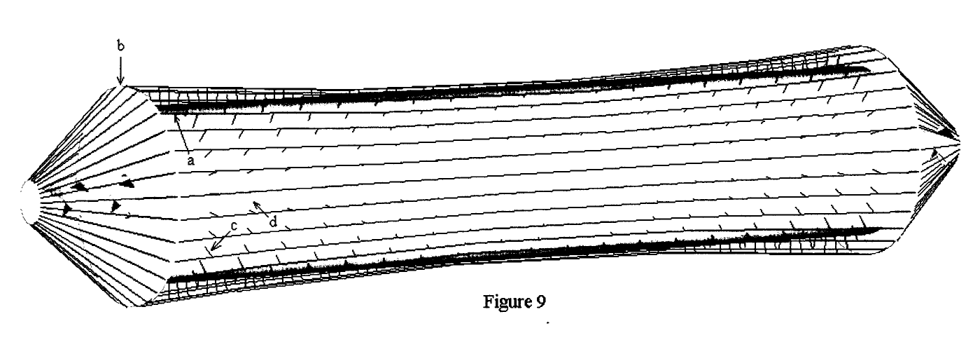

FIG. 10 shows that you could also have support cables (a) running axially along the inside of the outer tube; one for each suspension cable (b). You could then terminate the cable stays (c) on these support cables (a). In this way, the outer fabric tube (not shown) would be better supported. Also not shown; you could allow the cable stays to continue in to the center of the structure and out to the opposing suspension cable. This would give the structure greater rigidity.

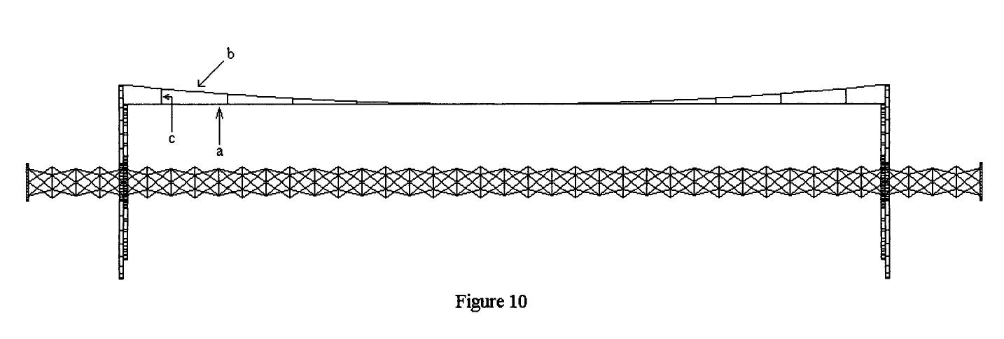

FIG. 11 shows an embodiment where the outer tube (a) is supported by laying it directly on the suspension cables (not shown). The advantage of this configuration is greater volume. Also this configuration does not require cable stays or support cables, which reduces weight and makes assembly much simpler. The challenge with this type of construction is to vary the cross-sectional diameter of the tubing such that axial cross-section would appear as a parabolic arc of the same shape you would have were you using suspension cables. Taking this idea a step further, it is even possible to eliminate the suspension cables if the tubing material is strong enough.

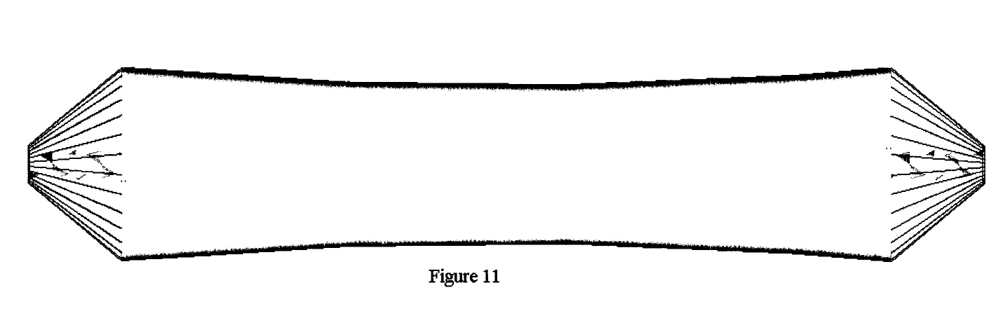

FIG. 12 is a wire frame view of one embodiment of the completed structure.

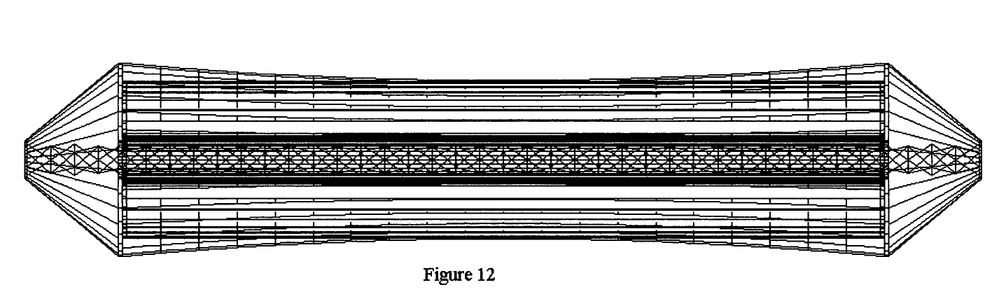

### DETAILED DESCRIPTION OF THE INVENTION

This invention defines a new tubular container (The Suspension Enclosure). This said suspension enclosure would be a suitable structure to use as a vehicle framework for use underwater because of its ability to stand up to enormous pressure. In the vacuum vessel configuration, I expect the strength to weigh ratio to be so high, that you could build a vacustat light enough to float in the atmosphere when evacuated of air. The vacustat is very resilient and forgiving of impact and deformation because, suspension enclosures have a remarkable ability to distribute point stresses throughout their entire structure. This gives the vacustat a good chance of surviving impact, wind shear and terrorist attack. The vacustat will pave the way for a new airship/air-crane industry that is no longer dependent on helium for lift. These airships will be less expensive to fly and will be able to control their buoyancy without the need to dump expensive helium in order to sink, or dump ballast in order to rise. But no matter how this suspension enclosure is used, it is sure to be fast, easy, and inexpensive to assemble because there are so few parts, and all parts are extremely easy to manufacture.

I claim:

1. A suspension enclosure framework comprised of two or more freestanding balanced suspension tower arrays attached to each other by one or more columns either by direct contact with said columns or with tendons that join the said tower arrays to the said columns all for the purpose of maintaining a relatively fixed distance and angular relationship between the said freestanding balanced suspension tower arrays.

2. A suspension enclosure where a capped tube of any airtight material, cross-section, taper, or transition is stretched between a pair of freestanding balanced suspension tower arrays that are themselves part of a suspension enclosure framework, which was defined in claim one, all for the purpose of enclosing space.

3. A suspension enclosure as defined in claim two where any number of suspension cables are stretched between the said freestanding balanced suspension tower arrays and are used to support the said tube(s) either by directly laying the said tube(s) on the said suspension cables or by the use of cable stays and support cables.

4. The novel use of the said suspension enclosure to stand against pressure differentials where fluid or gas pressure outside the vessel is greater than the fluid or gas pressure inside the vessel.

5. The novel use of the said suspension enclosure as a vacustat.

6. The novel use of said suspension enclosure as a vehicle frame for use on land, under water, in the air or in outer space.
